(19) United States
(12) Patent Application Publication
(10) Pub. No.: US 2013/0221056 A1
(43) Pub. Date: Aug. 29, 2013

(54) NAIL GUN

(71) Applicant: Kun-Chi CHEN, Taichung City (TW)

(72) Inventor: Kun-Chi CHEN, Taichung City (TW)

(21) Appl. No.: 13/541,076

(22) Filed: Jul. 3, 2012

(30) Foreign Application Priority Data
Feb. 29, 2012 (TW) 101106605

(51) Int. Cl. B25C 5/16

(52) U.S. Cl. 227/120

(57) ABSTRACT

A nail gun includes a nail gun housing, a nail magazine detachably mounted in the nail gun housing and defining with the nail gun housing a nail crown receiving space and first, second and third nail leg receiving spaces, and a nail pusher for pushing a nail to a nailing position in the nail magazine, the nail pusher having a top portion positioned in the nail crown receiving space and first, second and third push portions respectively downwardly extended from two lateral sides and a second side of the top portion and respectively inserted into the first, second and third nail leg receiving spaces. Thus, a large contact surface area of the nail pusher can be abutted against the leg(s) of one of various types of nails to keep the nail accurately in the nailing position, avoiding tilting or any nailing errors.

### BACKGROUND OF THE INVENTION

1. Field of the Invention

The present invention relates to nail gun technology and more particularly, to a nail gun for nailing nails of different sizes.

2. Description of the Related Art

A nail gun that is applicable to different types of nails has a nail magazine configured to selectively accommodate different types of nails, such as T-shaped nails, I-shaped nails, or U-shaped nails. The nail pusher of this type of nail magazine can push any of the aforesaid various types of nails toward the nailing position. To fit different types of nails in different positions inside the nail magazine, the nail pusher is configured to provide multiple bends. Thus, different portions of the nail pusher are selectively used to stop against different types of nails without changing the mounting position of the nail pusher in the nail magazine.

However, this nail pusher simply has its front side stopped against a small area of each leg of the nail, and the nail may be kept in a tilted condition when reached the nailing position, causing nailing errors. An improvement in this regard is necessary. Further, U.S. Pat. No. 7,770,771 discloses a stapler with adjustable firing apparatus for using staples/nails in various sizes. According to this design, actuating means 50 is controlled to drive rotation engaged member 40 in moving adjusting means 30 subject to the type of staples/nails used. However, the mesh engagement relationship between the actuating means 50 and the rotation engaged member 40 cannot eliminate mobile space (displacement). In consequence, an eccentric torque and a component force can be produced during actuation of the actuating means 50, lowering transmission efficiency and accuracy and complicating the operation.

### SUMMARY OF THE INVENTION

The present invention has been accomplished under the circumstances in view. It is the main object of the present invention to provide a nail gun, which is suitable for using nails of different types, avoiding tilting the nail and further nailing errors.

To achieve this and other objects of the present invention, a nail gun comprises a nail gun housing, a nail magazine, and a nail pusher. The nail magazine is detachably mounted in the nail gun housing, defining with the nail gun housing a nail crown receiving space, and a first nail leg receiving space, a second nail leg receiving space and a third nail leg receiving space in communication with the nail crown receiving space. The nail pusher is slidably mounted in the nail magazine for pushing a nail to a nailing position, comprising a top portion positioned in the nail crown receiving space, a first push portion downwardly extended from the top portion and inserted into the first nail leg receiving space, a second push portion downwardly extended from the top portion and inserted into the second nail leg receiving space, and a third push portion downwardly extended from the top portion and inserted into the third nail leg receiving space. Thus, the first push portion, second push portion and third push portion of the nail pusher can push the leg of a nail in the first nail leg receiving space, second nail leg receiving space or third nail leg receiving space. Thus, a large contact surface area of the first push portion, second push portion and/or third push portion of the nail pusher can be abutted against the leg(s) of one of various types of nails to keep the nail accurately in the nailing position, avoiding tilting or any nailing errors.

Other and further benefits, advantages and features of the present invention will be understood by reference to the following specification in conjunction with the accompanying drawings, in which like reference characters denote like elements of structure.

### BRIEF DESCRIPTION OF THE DRAWINGS

FIG. 1 is an elevational view of a nail gun in accordance with a first embodiment of the present invention.

FIG. 2 is an exploded view of the nail gun in accordance with the first embodiment of the present invention.

FIG. 3 is an exploded view of the nail magazine and nail pusher of the nail gun in accordance with the first embodiment of the present invention.

FIG. 4 is a sectional view taken along line 4-4 of FIG. 1.

FIGS. 5-9 are similar to FIG. 4, illustrating different types of nails loaded in the nail magazine.

FIGS. 10-14 are schematic rear views of the pressure plate and guide plate of the nail gun in accordance with the first embodiment of the present invention, illustrating different types of nails stopped against the pressure plate.

FIG. 15 is an exploded view of a nail magazine housing, rod member and press device of a nail magazine for nail gun in accordance with a second embodiment of the present invention.

FIG. 16 is a sectional view of the nail magazine housing of the nail magazine of the nail gun in accordance with a second embodiment of the present invention.

FIG. 17 is an exploded view of a nail magazine housing, rod member and press device of a nail magazine for nail gun in accordance with a third embodiment of the present invention.

### DETAILED DESCRIPTION OF THE INVENTION

At first, it must be noted that, in the whole detailed description and claims of the invention, like reference numerals refer to like parts throughout the drawings and specification.

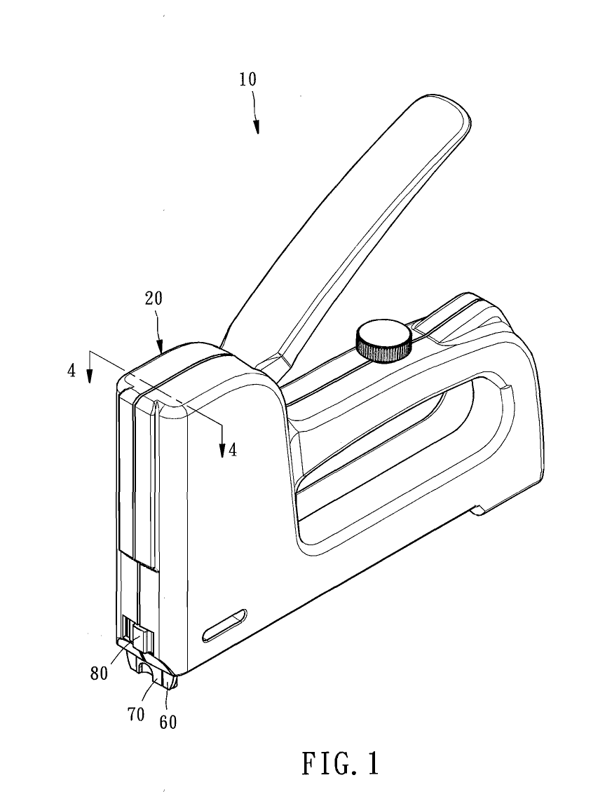

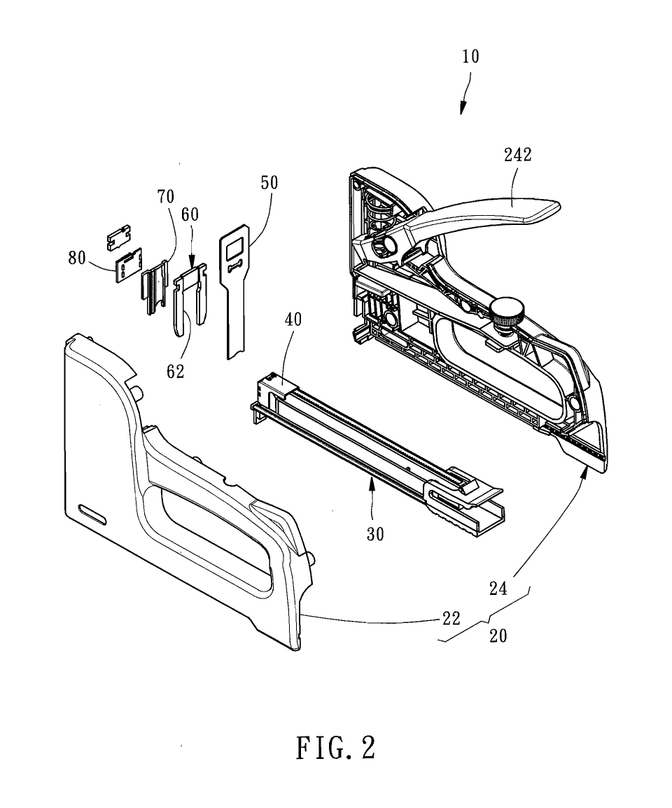

Referring to FIGS. 1 and 2, a nail gun 10 in accordance with a first embodiment of the present invention is shown comprising a nail gun housing 20, and a nail magazine 30, a nail pusher 40, a nail striker 50, a guide plate 60, a pressure plate 70 and a control member 80 accommodated in the nail gun housing 20.

The nail gun housing 20 comprises symmetrical left shell member 22 and right shell member 24, and an operating handle 242 mounted at the right shell member 24.

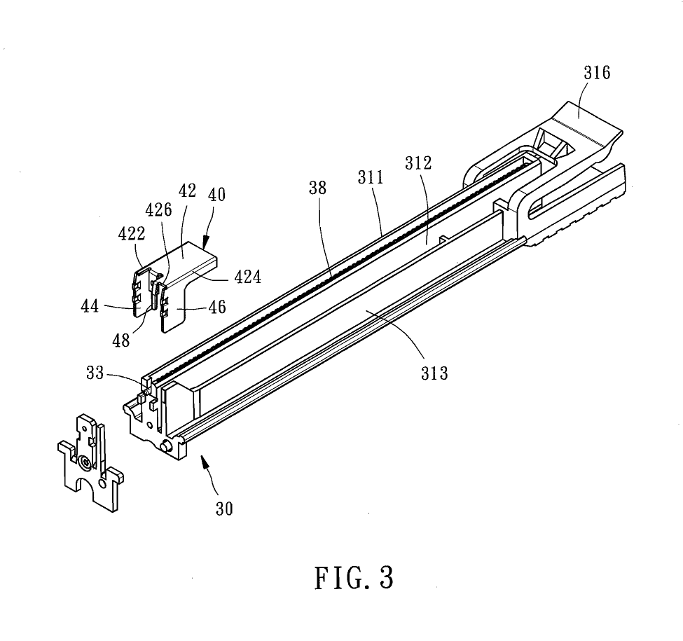

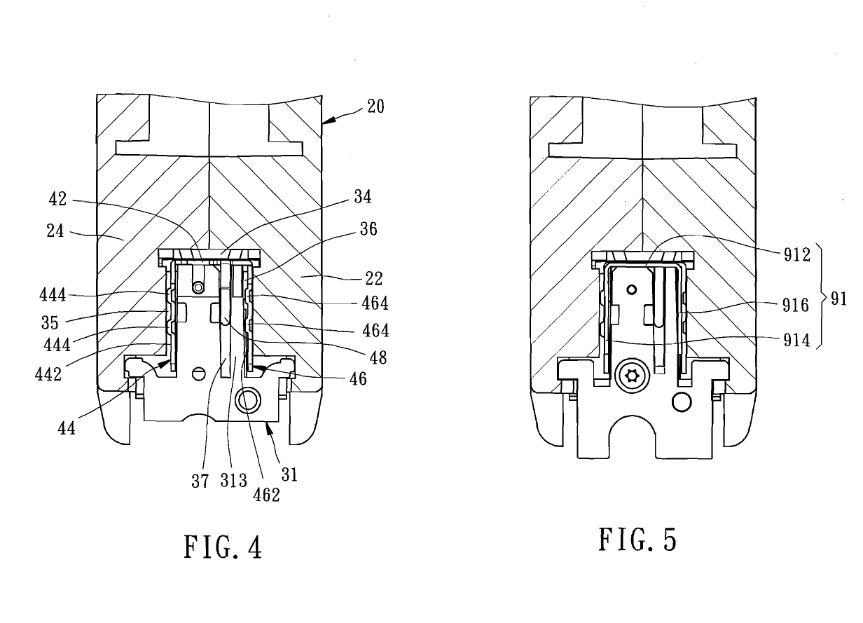

As illustrated in FIG. 3, the nail magazine 30 comprises a magazine housing 31 and a stop plate 32. The magazine housing 31 comprises a first partition plate 311, a second partition plate 312, a third partition plate 313, a press portion 316 disposed at a rear side of the partition plates 311;313;313, and a rod member 33 disposed between the first partition plate 311 and the second partition plate 312. The press portion 316 is pressable by a user to disengage the magazine housing 31 from the nail gun housing 20, allowing removal of the nail magazine 30 from the nail gun housing 20. As illustrated in FIG. 4, the magazine housing 31 and the nail gun housing 20 define therebetween a nail crown receiving space 34, and a first nail leg receiving space 35, a second nail leg receiving space 36 and a third nail leg receiving space 37 in communication with the nail crown receiving space 34. The first nail leg receiving space 35 is defined between the right shell member 24 and the first partition plate 311. The second nail leg receiving space 36 is defined between the left shell member 22 and the third partition plate 313. The third nail leg receiving space 37 is defined between the second partition plate 312 and the third partition plate 313. The stop plate 32 is configured to match the magazine housing 31, and affixed to the front side of the magazine housing 31.

The nail pusher 40 is mounted in the nail magazine 30 and connected to a front end of a follower spring 38, which is sleeved onto the rod member 33, and adapted for pushing loaded nails toward the front side of the nail magazine 30. The nail pusher 40 comprises a top portion 42 supported on the first partition plate 311, second partition plate 312 and third partition plate 313 of the magazine housing 31, a first push portion 44 downwardly extended from a right side 422 of the top portion 42 and inserted into the first nail leg receiving space 35, a second push portion 46 downwardly extended from a left side 424 of the top portion 42 and inserted into the second nail leg receiving space 36, and a third push portion 48 downwardly extended from a front side 426 of the top portion 42 and inserted into the third nail leg receiving space 37. Further, the first push portion 44 defines a lateral wall 442 facing toward the right shell member 24 of the nail gun housing 20, and two protruding blocks 444 protruded from the lateral wall 442. The second push portion 46 defines a lateral wall 462 facing toward the third partition plate 313 of the magazine housing 31, and two protruding blocks 464 protruded from the lateral wall 462.

The nail striker 50, the guide plate 60, the pressure plate 70 and the control member 80 are mounted in a front side inside the nail magazine 30 in a proper order. When the user presses the operating handle 242, the nail striker 50 will be moved downwardly along a sliding groove 62 of the guide plate 60 to strike the nail that is supported on the pressure plate 70 in the nailing position right below the nail striker 50, thereby driving the nail out of the nail gun into an external object. The control member 80 is movable left and right by the user to adjust the distance between the pressure plate 70 and the nail magazine 30 subject to the thickness of the nails to be used, so that only one nail can be driven out of the nail gun upon each down stroke of the nail striker 50. Because the control member 80 is straightly linearly movable left and right to adjust the position of the pressure plate 70, the user can conveniently and accurately adjust the distance between the pressure plate 70 and the nail magazine 30. This adjustment procedure is much easier than the prior art techniques, and the transmission efficiency is also higher.

It is to be noted that the stop plate 32 of the nail magazine 30 is made of a much stronger material than the magazine housing 31 for working as a barrier between the magazine housing 31 and the nail striker 50 to protect the magazine housing 31 against mechanical wear. However, the nail magazine 30 can be made without the stop plate 32.

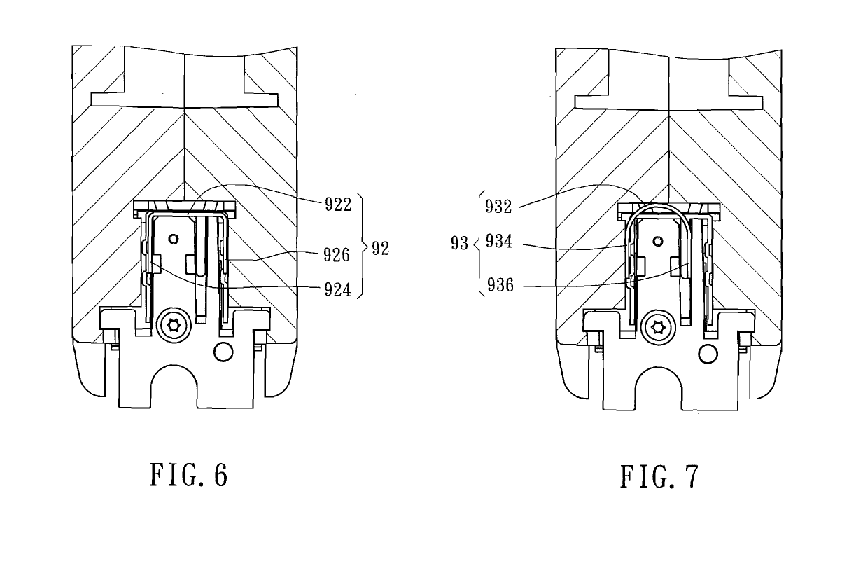

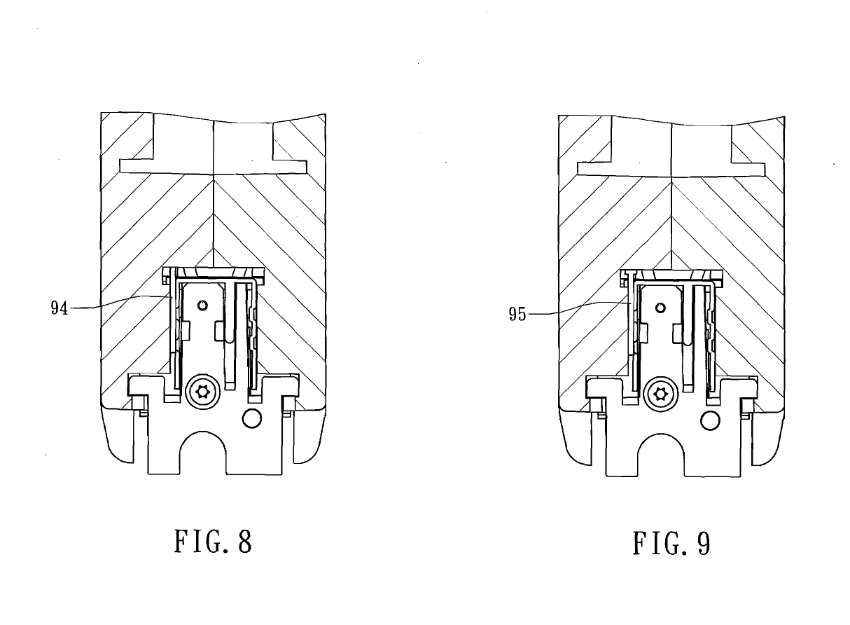

As shown in FIG. 5, when a first flat crown nail 91 is loaded in the nail magazine 30, the crown 912 and two legs 914;916 of the first flat crown nail 91 will be respectively pushed by the top portion 42, first push portion 44 and protruding blocks 464 of second push portion 46 of the nail pusher 40. As shown in FIG. 6, when a second flat crown nail 92 that is relatively wider and shorter than the aforesaid first flat crown nail 91 is loaded in the nail magazine 30, the crown 922 and two legs 924;926 of the second flat crown nail 92 will be respectively pushed by the top portion 42, first push portion 44 and second push portion 46 of the nail pusher 40. As shown in FIG. 7, when a U-shaped nail 93 is loaded in the nail magazine 30, the crown 932 and two legs 934;936 of the U-shaped nail 93 will be respectively pushed by the top portion 42, protruding blocks 444 of first push portion 44 and third push portion 48 of the nail pusher 40. As shown in FIGS. 8 and 9, when an I-shaped nail 94 or T-shaped nail 95 of a single leg type is loaded in the nail magazine 30, the nail 94;95 will be pushed by the protruding blocks 444 of the first push portion 44 of the nail pusher 40.

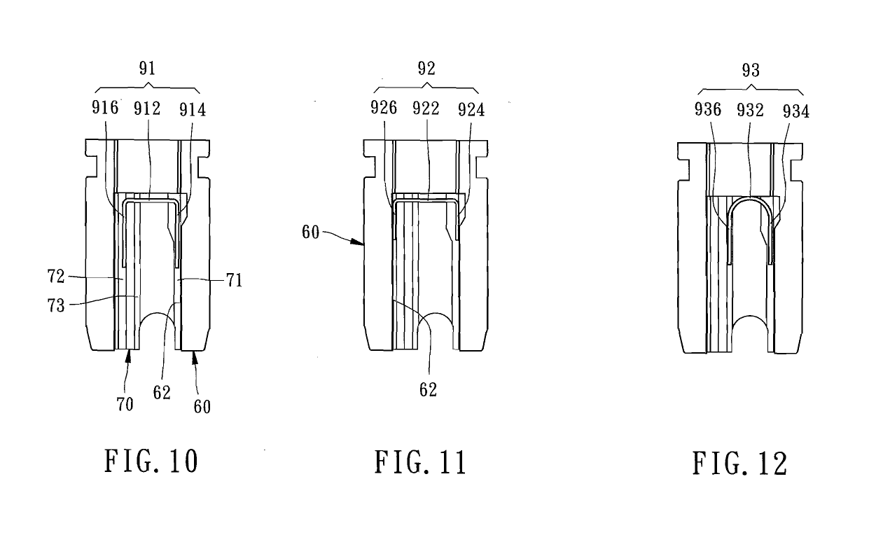

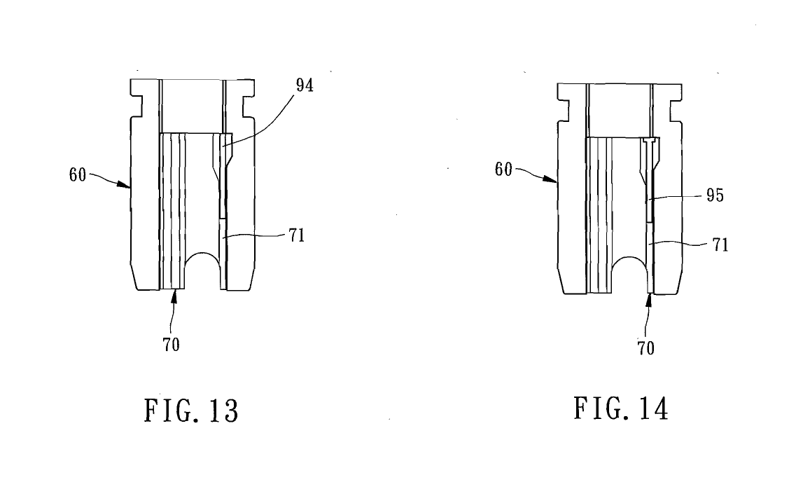

Referring to FIGS. 10-14, the pressure plate 70 comprises a first sliding groove 71, a second sliding groove 72 and a third sliding groove 73 respectively facing toward the first push portion 44, second push portion 46 and third push portion 48 of the nail pusher 40. When one of the aforesaid five different types of nails is loaded in the nail magazine and pushed into the nailing position, it can be guided by at least one of the sliding grooves 71;72;73 of the pressure plate 70 and the sliding groove 62 of the guide plate 60, avoiding nailing errors. More importantly, a large contact surface area of the first push portion 44, second push portion 46 and/or third push portion 48 of the nail pusher 40 can be abutted against the leg(s) of any of the aforesaid various types of nails to keep the nail accurately in the nailing position, avoiding tilting or any nailing errors.

In the aforesaid first embodiment of the present invention, the third partition plate 313 of the magazine housing 31 has its front end kept in flush with the topmost edges of the first and second partition plates 311;312 and its other part spaced below the elevation of the topmost edges of the first and second partition plates 311;312, facilitating the fabrication of the magazine housing 31 by a plastic injection molding process.

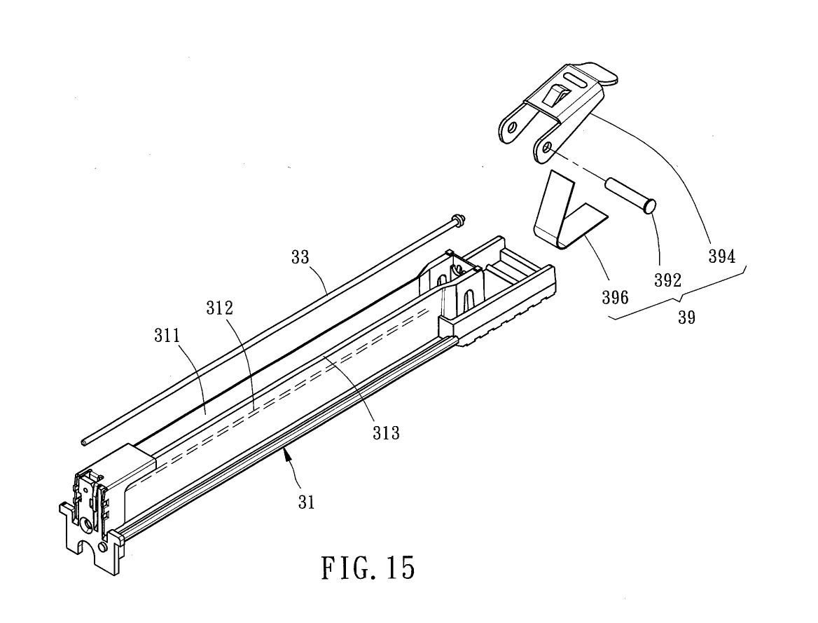

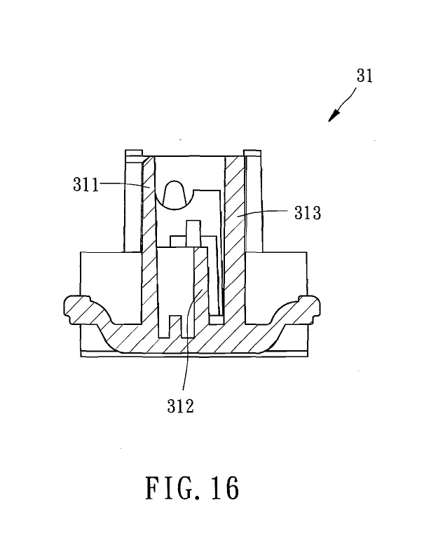

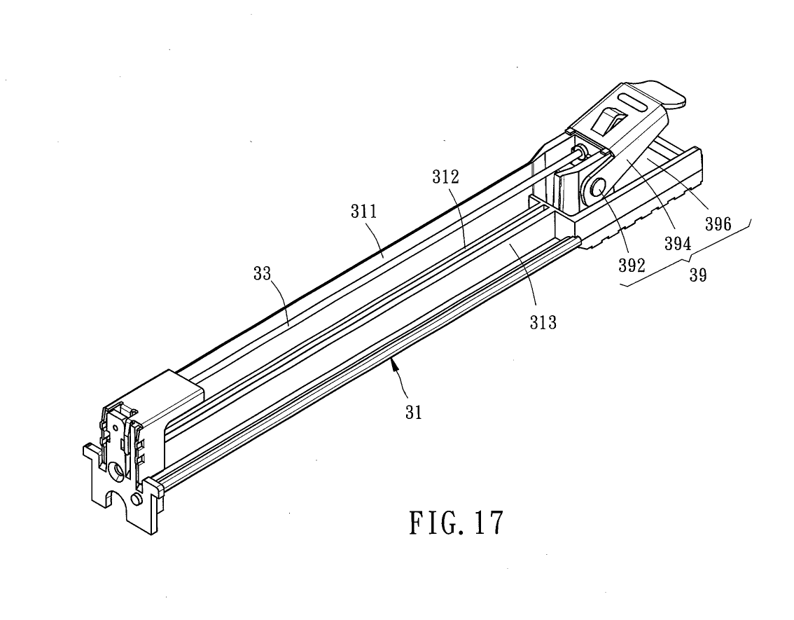

According to a second embodiment of the present invention, as shown in FIGS. 15 and 16, the second partition plate 312 of the magazine housing 31 has a height lower than the first and third partition plates 311;313. According to a third embodiment of the present invention, as shown in FIG. 17, the second and third partition plate 312;313 of the magazine housing 31 have a height lower than the first partition plate 311. All these designs facilitate the fabrication of the magazine housing 31, avoiding deformation.

Further, as shown in FIG. 15 and FIG. 17, a press device 39 may be used in the nail magazine 30 to substitute for the press portion 316 of the magazine housing 31. The press device 39 comprises a pivot 392 transversely inserted through the magazine housing 31, a press member 394 coupled to and turnable about the pivot 392, and an elastic member 396 for returning the press member 394. A user can press the press member 394 to disengage the nail magazine 30 from the nail gun housing 20 and then remove the nail magazine 30 out of the nail gun housing 20.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A nail gun, comprising:
a nail gun housing;
a nail magazine detachably mounted in said nail gun housing, said nail magazine defining with said nail gun housing a nail crown receiving space, and a first nail leg receiving space, a second nail leg receiving space and a third nail leg receiving space in communication with said nail crown receiving space; wherein said nail magazine comprises a first partition plate, a second partition plate, and a third partition plate; said first nail leg receiving space is defined between said nail gun housing and said first partition plate; said second nail leg receiving space is defined between said nail gun housing and said third partition plate; said third nail leg receiving space is defined between said second partition plate and said third partition plate; and
a nail pusher slidably mounted in said nail magazine for pushing a nail to a nailing position, said nail pusher comprising a top portion positioned in said nail crown receiving space, a first push portion downwardly extended from said top portion and inserted into said first nail leg receiving space, a second push portion downwardly extended from said top portion and inserted into said second nail leg receiving space, and a third push portion downwardly extended from said top portion and inserted into said third nail leg receiving space.

2. The nail gun as claimed in claim 1, wherein said first push portion, said second push portion and said third push portion are formed integral with and respectively downwardly extended from two opposing lateral sides and a front side of said top portion.

3. The nail gun as claimed in claim 1, wherein said first push portion comprises a lateral wall facing toward said nail gun housing, and a plurality of protruding blocks protruded from said lateral wall.

4. The nail gun as claimed in claim 1, wherein said second push portion comprises a lateral wall facing toward said nail gun housing, and a plurality of protruding blocks protruded from said lateral wall.

5. The nail gun as claimed in claim 1, further comprising a pressure plate located on a front side of said nail magazine, said pressure plate comprising a first sliding groove, a second sliding groove and a third sliding groove respectively facing toward said first push portion, said second push portion and said third push portion of said nail pusher.

6. The nail gun as claimed in claim 1, wherein said top portion of said nail pusher are supported on and movable along at least one of said partition plate, said second partition plate and said third partition plate of said nail magazine.

7. The nail gun as claimed in claim 1, wherein said third partition plate of said nail magazine has at least one part thereof disposed below the elevation of the topmost edge of said first partition plate.

8. A nail gun, comprising:
a nail gun housing;
a nail magazine detachably mounted in said nail gun housing, said nail magazine defining with said nail gun housing a nail crown receiving space, and a first nail leg receiving space, a second nail leg receiving space and a third nail leg receiving space in communication with said nail crown receiving space;
a nail pusher slidably mounted in said nail magazine for pushing a nail to a nailing position, said nail pusher comprising a top portion positioned in said nail crown receiving space, a first push portion downwardly extended from said top portion and inserted into said first nail leg receiving space, a second push portion downwardly extended from said top portion and inserted into said second nail leg receiving space, and a third push portion downwardly extended from said top portion and inserted into said third nail leg receiving space;
a pressure plate located on a front side of said nail magazine, said pressure plate comprising a first sliding groove, a second sliding groove and a third sliding groove respectively facing toward said first push portion, said second push portion and said third push portion of said nail pusher; and
a control member movably mounted at said nail gun housing and adapted for moving said pressure plate to adjust the distance between said pressure plate and said nail magazine.

9. The nail gun as claimed in claim 8, wherein said nail magazine comprises a first partition plate, a second partition plate, and a third partition plate; said first nail leg receiving space is defined between said nail gun housing and said first partition plate; said second nail leg receiving space is defined between said nail gun housing and said third partition plate; said third nail leg receiving space is defined between said second partition plate and said third partition plate.
